(19) United States
(12) Patent Application Publication
(10) Pub. No.: US 2008/0142037 A1
(43) Pub. Date: Jun. 19, 2008

(54) Apparatus and method for cleaning liquid dispensing equipment

(76) Inventors: James L. Dempski, Green Oaks, IL (US); Noman A. Abunimeh, Grayslake, IL (US); Kurt M. Klosterman, Gurnee, IL (US); Paul A. Matuszewski, Wauconda, IL (US)

Correspondence Address: PAUL D. YASGER;ABBOTT LABORATORIES, 100 ABBOTT PARK ROAD, DEPT. 377/AP6A, ABBOTT PARK, IL, 60064-6008, US

(21) Appl. No.: 11/641,338

(22) Filed: Dec. 19, 2006

(51) Int. Cl. B08B 3/12

(52) U.S. Cl. 134/1

(57) ABSTRACT

A method for cleaning deposits of particulate material from the tip of a nozzle of a dispensing apparatus, such as, for example, the tip of the nozzle of a liquid reagent dispensing apparatus. The method involves the use of a multiple excitation signal waveform to cavitate and agitate the cleaning medium in which the tip of the nozzle is suspended. Multiple excitation refers to a method of excitation that uses waves of alternating polarity; multiple excitation may involve excitation at a plurality of frequencies in sequence, at a plurality of amplitudes in sequence, at a plurality of waveforms in sequence, combinations of the aforementioned frequencies, amplitudes, and waveforms. The invention also provides an apparatus incorporating electrical and mechanical components, along with appropriate software, sufficient to perform the method described herein.

### BACKGROUND OF THE INVENTION

1. Field of the Invention

This invention relates to cleaning of liquid dispensing equipment, more particularly to cleaning of liquid dispensing equipment in automated laboratory apparatus.

2. Discussion of the Art

In large, high volume diagnostic laboratories employing automated diagnostic instruments, the repetitive processes for dispensing reagents causes nozzles of dispensing instruments to accumulate deposits of particulate material. The deposits of particulate material result from not only the high volumes of liquids dispensed, but also from the drying of particulate material during intervals between dispensing steps, the pull-back of liquids within the nozzle, and the surface tension of the liquids.

The intervals between dispensing steps allows particulate material within a reagent to migrate to the surface of the nozzle and bond to the surface of the nozzle. The next dispensing step from the nozzle may or may not dislodge the bonded particulate material from the surface of the nozzle.

The pull-back of liquids at the end of each dispensing step leaves a film of particulate reagent material on account of exposure to air (air void) on the interior surface of the nozzle, and leaves a film on the exterior surface of the nozzle on account of reagent shearing. For example, in certain instruments, reagents can be dispensed for approximately 100 ms through fixed-head nozzles approximately every 40 seconds. The volume of liquid dispensed, e.g., 50 μL, and the relatively small openings of tips of dispensing instruments require that the fluid dispensed be sheared at the end of each dispensing step. Reagent shearing occurs when the movement of a column of fluid is terminated abruptly, whereby a tearing of the column of fluid occurs; that is, the column of fluid is sheared. In the act of shearing the dispensed fluid, the fluid that is in motion through the nozzle retracts a small amount (i.e., pulls back), thereby exposing the interior walls of the end of the tip of the nozzle to air, i.e., the air void referred to previously. Shearing at the end of each dispensing step is required to minimize hanging drops on the tip of the nozzle, which could occur if the liquid is sheared too slowly. Over time, this continuous dispensing, that is, every 40 seconds, leads to coating the interior surface of the tip of the nozzle and reduces the interior diameter of the tip of the nozzle. The instrument needs to be disassembled periodically so that the coating on the nozzle can be cleaned or the nozzle can be replaced.

In addition, when exiting the dispensing nozzle, the diameter of the reagent stream expands slightly. When shearing occurs at the completion of each dispensing step, the central portion of the reagent stream above the shear points retracts into the end of the nozzle, and occasionally a small amount of the reagent stream from the remaining ring of reagent lands on the exterior surface of the nozzle. The liquid reagent is allowed to dry in an environment of elevated temperature, with the resultant formation of a deposit of particulate material on the exterior surface of the nozzle. Depending upon the composition of the reagent, the deposit of particulate material may crystallize. Accumulation of deposits of particulate material, over a long period of time, may adversely affect subsequent streams of liquid being dispensed by diverting the path of the stream as it exits the tip of the nozzle. The diversion of the stream can contribute to dispensing errors, because detection sensors located in the nominal trajectory of the fluid stream are used for dispense verification. Certain instruments utilize an optical dispense verification system, wherein a source of light and a detector therefor monitor the fluid dispensed from a nozzle, the stream of fluid dispensed normally intersecting the optical path between the detector and the source of light. If a portion of the stream of fluid is diverted to one side or another, the optical system will detect an abnormal reading and, accordingly, will report a fluid dispensing error. Each fluid dispensing error causes the user to repeat testing of affected samples at a later time, thereby delaying the reporting of test results.

Instruments are typically serviced quarterly, on account of service efficiencies. Inspection, cleaning, or replacement of nozzles is performed during the quarterly maintenance procedure. Several patents and publications have attempted to address the problem of cleaning various types of equipment. U. S. Patent Application Publication No. 2002/0069893 discloses a method and apparatus utilizing ultrasonic vibration for cleaning the interior of a channel of a medical instrument. U.S. Pat. No. 6,446,642 discloses a method and apparatus to clean an inkjet reagent deposition device by means of a reverse flushing technique optionally used in combination with sonication. U.S. Patent Application Publication No. 20060179946 discloses a method and apparatus for washing a probe using ultrasonic energy. U.S. Pat. No. 5,895,997 discloses a generator for driving an ultrasonic transducer for use in ultrasonic cleaning. The generator is capable of maintaining substantially constant real output to a load while the output frequency of the generator is square wave frequency modulated about a wide bandwidth. The square wave modulation of the output frequency causes improved cavitation of semi-aqueous cleaning solutions used in the load, and thus improves the cleaning action of the ultrasonic transducer. U.S. Pat. No. 7,077,018 discloses a volume displacement pipette that includes a channel within the piston. The channel allows for cleaning fluids to be continuously run through the pipette tip for cleaning the tip. U. S. Patent Application Publication No. 2005/0061355 discloses a cleaning device for cleaning an object including an inner vessel configured to contain a first liquid and the object. The cleaning device also includes an external vessel configured to contain a second liquid and the inner vessel. The second liquid is acoustically coupled to the first liquid. At least one transducer is acoustically coupled to the external vessel and configured to generate acoustical energy, which is transferred to the object through the external vessel, the second liquid, the inner vessel and the first liquid. WO 2004/108169 discloses a cavitation-generating device for cleaning, sterilizing and disinfecting objects inside an enclosure or the enclosure itself.

It would be desirable to develop a cleaning method that would allow laboratory technicians to perform the cleaning of dispensing nozzles without having to disassemble the automated diagnostic instrument. It would be further desirable to ensure that the dispensing nozzle is clean in order to minimize test error reports as a result of deposits of particulate material on the surface of the nozzle.

### SUMMARY OF THE INVENTION

This invention provides a method for cleaning deposits of particulate material from the tip of a nozzle of a dispensing apparatus, such as, for example, the tip of the nozzle of a liquid reagent dispensing apparatus. The method involves the use of a multiple excitation signal waveform to cavitate and agitate the cleaning medium in which the tip of the nozzle is suspended. Multiple excitation refers to a method of excitation that uses waves of alternating polarity; multiple excitation may involve excitation at a plurality of frequencies in sequence, at a plurality of amplitudes in sequence, at a plurality of waveforms in sequence, or combinations of the aforementioned frequencies, amplitudes, and waveforms. The invention also provides an apparatus incorporating electrical and mechanical components, along with appropriate software, sufficient to perform the method described herein.

In one aspect, the invention comprises a method comprising the steps of:
(a) providing a nozzle for dispensing a liquid material, the nozzle having a tip having an interior surface and an exterior surface, the liquid material capable of depositing a residue of particulate material on the interior surface of the tip of the nozzle or on the exterior surface of the tip of the nozzle or on both the interior and exterior surfaces of the tip of the nozzle;
(b) providing a cleaning apparatus comprising a container for holding a liquid for cleaning the tip of the nozzle;
(c) generating ultrasonic excitation by means of the cleaning apparatus to create bubbles in the cleaning liquid contained in the container; and
(d) removing any residue from the interior surface of the tip of the nozzle and the exterior surface of the tip of the nozzle.
   Certain parameters can be selected for optimal use of the apparatus and method described herein. These parameters include, for example, frequency, amplitude, and waveform of the output of the signal generator, the size and shape of the container for holding the liquid for cleaning the tip of the nozzle, and the mechanical fastening of the container to the platform for supporting the container. The signal generator can generate various waveforms, such as, for example sine waves and square waves. A representative example of a waveform suitable for use in this invention is a sine wave having a peak-to-peak value of at least 100 Volts at a frequency of at least 50 kHz. In addition, the container must be of a size that renders it suitable for use in the apparatus in which it will be used.

In another aspect, an apparatus suitable for carrying out the method of this invention comprises:
(a) a container for holding a cleaning liquid;
(b) a support for the container;
(c) a piezoelectric element;
(d) a signal generator; and
(e) a piezoelectric operational amplifier/driver.
   The signal generator is preferably capable of generating various waveforms and various frequencies between 20 kHz and 200 kHz. The piezoelectric element is capable of being driven at ultrasonic frequencies when coupled to the container for holding the cleaning liquid.

### BRIEF DESCRIPTION OF THE DRAWINGS

FIG. 1 is a schematic diagram illustrating a normal stream of liquid being dispensed from a nozzle into a reaction tray of an automated apparatus and a diverted stream of liquid being dispensed from a nozzle into a reaction tray of an automated apparatus.

FIG. 2 is a schematic diagram illustrating an apparatus suitable for carrying out the method of this invention.

FIG. 3A is a side view in elevation of a nozzle of the type that is capable of being cleaned by the method and apparatus described herein.

FIG. 3B is a bottom plan view of the nozzle shown in FIG. 3A.

FIG. 4 is a cross-sectional view of the nozzle of FIG. 3A taken along line 4-4.

FIG. 5 is a view of the tip of the nozzle shown in FIG. 4, greatly enlarged.

FIG. 6A is a side view in elevation of a container suitable for use with the method and apparatus described herein.

FIG. 6B is a top plan view of the container shown in FIG. 6A.

FIG. 7A is a side view in elevation of a container suitable for use with the method and apparatus described herein.

FIG. 7B is a top plan view of the container shown in FIG. 7A.

FIG. 8A is a side view in elevation of a container suitable for use with the method and apparatus described herein.

FIG. 8B is a top plan view of the container shown in FIG. 8A.

FIG. 9A is a side view in elevation of a container suitable for use with the method and apparatus described herein.

FIG. 9B is a top plan view of the container shown in FIG. 9A.

FIG. 10A is a side view in elevation of a container suitable for use with the method and apparatus described herein.

FIG. 10B is a top plan view of the container shown in FIG. 10A.

FIG. 11A is a side view in elevation of a container suitable for use with the method and apparatus described herein.

FIG. 11B is a top plan view of the container shown in FIG. 11A.

### DETAILED DESCRIPTION

As used herein, the expression “signal generator” means a device used to produce an alternating electrical output signal that can be amplified to drive a piezoelectric element. Signal generators suitable for use herein include, but are not limited to, test signal generators, function generators, arbitrary waveform generators. The term “waveform” means a time varying electrical signal typically described by specifying an amplitude, a frequency or period, a shape, and any modulation characteristic. Waveforms suitable for use in this invention include, but are not limited to, sinusoidal, square, triangular, sawtooth. As used herein, the expression “ultrasonic excitation” means excitation by sound vibrations—variations of density in elastic media (e.g., air)—wherein the frequencies are beyond the auditory limit, i.e., above approximately 20,000 cycles per second. Such high frequency elastic vibrations can be produced in different ways, based on different physical principles. As used herein, the term “cavitation” means a process where small bubbles in a liquid are forced to oscillate in the presence of an acoustic field, when the intensity of the acoustic field is insufficient to cause total bubble collapse. The process of cavitation brings about agitation by a multiplicity of small and intensely imploding bubbles of liquid that create a highly effective scrubbing action on the surface of an object and within apertures of an object.

In the method described herein, ultrasonic excitation brought about by a piezoelectric transducer creates micrometer-sized bubbles by means of alternating positive and negative pressure waves within a liquid medium. These bubbles vary in size based on frequencies, power levels, surface tension properties of the liquid medium, and the geometric arrangement of the mechanical assembly producing the bubbles. The bubbles collect and expand on the interior and exterior surfaces of the tip of the nozzle up to and including the point of implosion. The continuing formation of bubbles and implosions of bubbles produce high temperature shock waves on the interior surface and the exterior surface of the tip of the nozzle. The shock waves break up the reagent deposits into small particles, freeing them from the bond to the interior surface and the exterior surface of the tip of the nozzle. The particles are then absorbed by or dissolved in or both by the liquid cleaning medium. This process gives bubbles the ability to form within the small inside diameters of the tip of the dispensing nozzle and remove the deposits therein.

A byproduct of ultrasonic excitation is agitation of the liquid in the container for holding the cleaning liquid, which agitation aids in moving particulate material away from the tip of the dispensing nozzle and also ensures that the cleaning medium is forced inside the small inside diameter of the tip of the dispensing nozzle during ultrasonic cleaning.

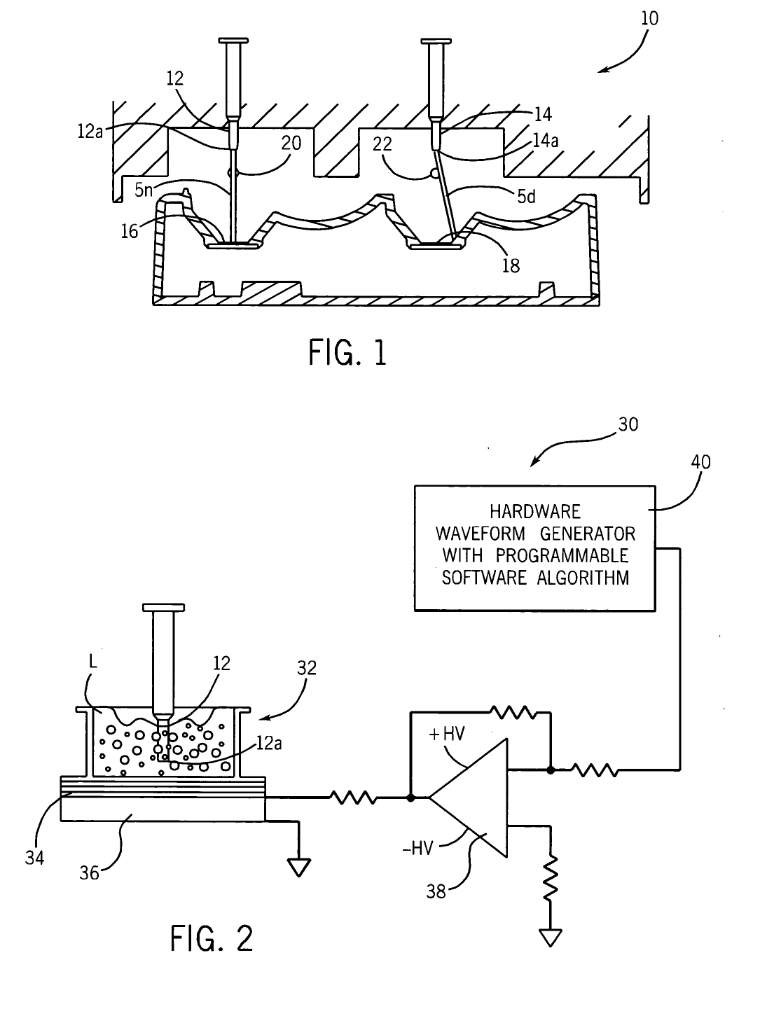

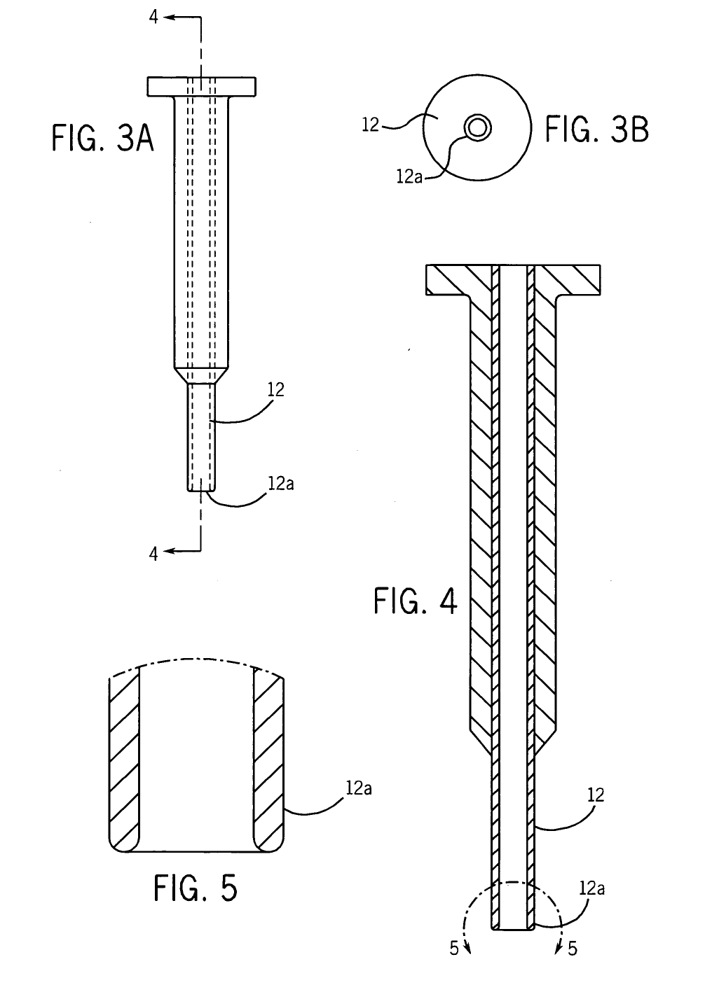

Referring now to FIG. 1, a nozzle arrangement 10 comprises a first nozzle 12 having a tip 12a and a second nozzle 14 having a tip 14a. The first nozzle 12 can dispense liquids into a receptacle 16 by means of a normal stream Sₙ. The second nozzle 14 can dispense liquids into a receptacle 18 by means of a diverted stream S_{d}. Dispense verification detectors 20 and 22 indicate the presence or absence of a normal stream of liquid. The diverted stream S_{d} is caused by residue that has accumulated on the interior surface of the tip 14a of the second nozzle 14, the exterior surface of the tip 14a of the second nozzle 14, or both the interior surface of the tip 14a of the second nozzle 14 and the exterior surface of the tip 14b of the second nozzle 14.

FIG. 2 illustrates an apparatus 30 suitable for carrying out the method described herein. The apparatus 30 comprises a container 32 for holding a cleaning liquid “L” resting upon a container support 34, which in turn rests upon a piezoelectric element 36. The piezoelectric element 36 is electrically connected to a piezoelectric operational amplifier/driver 38. A signal generator having programmable software 40 is connected to the piezoelectric operational amplifier/driver 38. A nozzle 12 having a tip 12a is immersed in the cleaning liquid “L” held in the container 32.

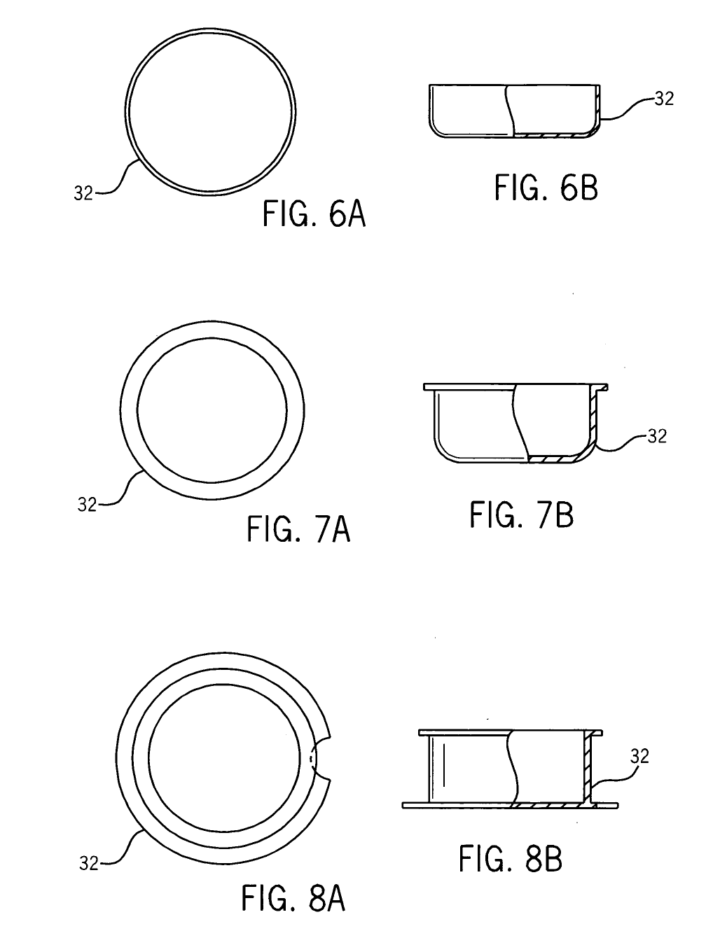

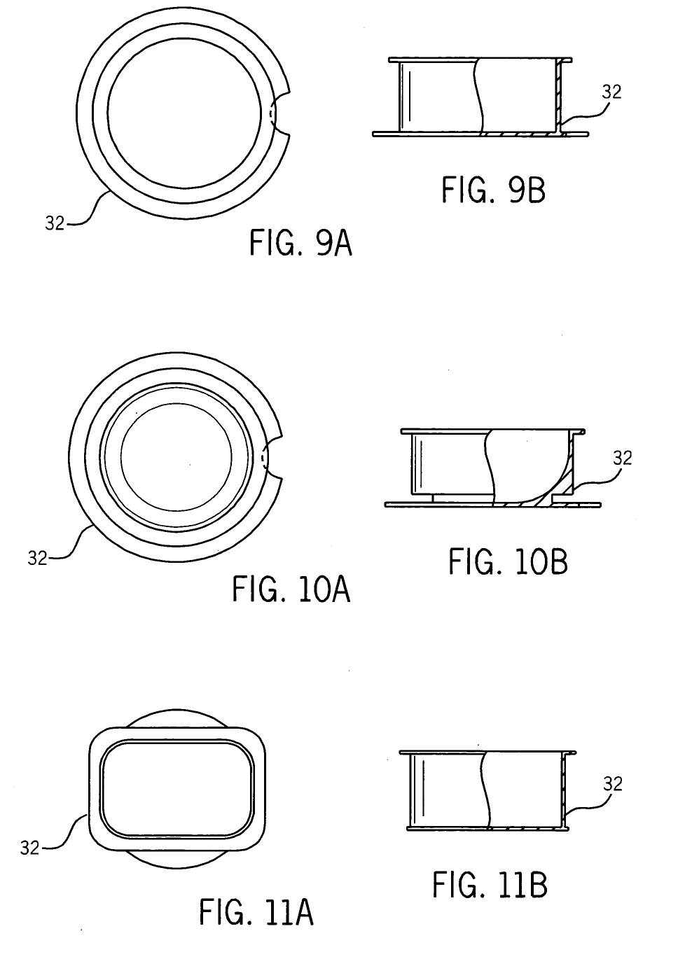

The container 32 is typically made of a rigid, durable material, such as, for example, ceramic or stainless steel. A rigid container will remain stiff at high excitation frequencies so that the maximum amount of energy generated at the piezoelectric element 36 can be transferred to the cleaning liquid “L” held by the container 32. A durable container 32 will be resistant to damage from physical shock, vibration, temperature, humidity, and other conditions encountered during operation of the apparatus and method described herein. The container 32 is preferably capable of being cleaned after it has been used in a cleaning operation. The container 32 is preferably made of the durable material so it will be resistant to corrosion. The container 32 is preferably made of a sufficiently rigid material to ensure efficient transfer of the energy waves delivered from the piezoelectric element 36 into the cleaning liquid “L”. The electrical properties of the container 32 are not critical to the design of the container 32. The purpose of the container 32 is to hold the cleaning liquid “L” and to transfer the energy from the piezoelectric element 36 to the tip 12a of the dispensing nozzle 12. The approximate size of the container 32 is limited by to the physical constraints of the arrangement employed to support the dispensing nozzle(s) in an automated apparatus. In certain types of apparatus, brackets hold the dispensing nozzles in such a position whereby reagents can be dispensed into reaction trays. The method and apparatus described herein can be used to clean the tips of those nozzles that are mounted in those brackets. The physical constraints of the brackets frequently limit the dimensions of the container 32. A typical container 32 suitable for use in this invention has the approximate size of 0.45 inch wide by 0.75 inch long by 0.35 inch high. FIGS. 6A, 6B, 7A, 7B, 8A, 8B, 9A, 9B, 10A, 10B, 11A, and 11B illustrate various shapes of containers that are suitable for use in the method and apparatus described herein.

The container support 34 is typically a composite material comprising an epoxy polymer bonded to a fiberglass mesh. The epoxy polymer is selected so that it will not break down after repeated exposure to the ultrasonic vibrations. In one embodiment, the epoxy material can be 0.010-inch thick material formed from “ECCOBOND 45” epoxy resin with Catalyst 15 (e.g., 100 parts resin to 50 parts catalyst), commercially available from Emerson & Cuming, Billerica, Mass., and the fiberglass mesh can be 0.005-inch thick plain weave fiberglass mesh compressed together to form a monolithic bond. It is preferred that the stiffness of the composite material be at least about 80 D (Durometer reading) in order to transfer sufficient energy from the piezoelectric element 36 to the container support 34. The function of the container support 34 is to position the container 32 in such a manner that the tip 12a of the dispensing nozzle 12 that is to be cleaned will be immersed in the cleaning liquid “L” contained in the container 32. In order to transfer energy from the piezoelectric element 36, the container support 34 must allow the container 32 to maintain a non-rigid mechanical coupling to the mechanism (not shown) employed for positioning of the container 32, the container support 34, and the piezoelectric element 36 adjacent to the tip 12a of the nozzle 12 so that the tip 12a of the nozzle 12 will be immersed in the cleaning liquid “L” contained by the container 32 while having the capability of minimizing or at least reducing splashing of liquid outside the container 32, which may occur during the cleaning cycle. A positioning mechanism suitable for use in this invention can be based on either a micromotor or a deflatable bladder, either of which can be employed to move the container 32 sufficiently close to the tip 12a of the nozzle 12 to immerse the tip 12a of the nozzle 12 in the cleaning liquid “L” contained in the container 32. Mechanical coupling refers to the mechanical connection between the container 32 and the aforementioned positioning mechanism. It is preferred that this mechanical connection be mechanically “loose” or “not rigid.” By keeping this mechanical connection loose, transfer losses from the piezoelectric element 36 to the positioning mechanism will be minimized or greatly reduced. If the mechanical coupling is too tight, the vibrations of the piezoelectric element 36 will be excessively damped. However, if the mechanical coupling is too loose, the container 32 will not maintain its proper position during the cleaning operation. Accordingly, the mechanical connection between the container 32 and the mechanism for positioning the container 32 must be sufficiently loose in order to allow the container 32 to vibrate, but must not be so loose that the container 32 cannot be positioned firmly in place and sealed, in order to contain any liquid that splashes during the cleaning process. The container support 34 must be of a size sufficient to accommodate the container 32. As stated previously, a typical container 32 suitable for use in this invention has the dimensions of approximately 0.45 inch wide by 0.75 inch long by 0.35 inch high. The container support 34 is typically made of a material that is resistant to corrosion, such as, for example, stainless steel or aluminum coated or treated to avoid oxidation of the aluminum. The aluminum can be anodized or coated with a “Teflon” coating. The electrical properties of the container support 34 are not critical to the invention.

It is preferred that the piezoelectric element 36 for the method and apparatus of this invention be rigid. In the case of the piezoelectric element, “rigid” means a stiff, non-compliant material that should remain rigid when excited by ultrasonic energy, so that the transfer of energy generated by the apparatus is not adversely affected, i.e., excessively reduced. The piezoelectric element 36 is a sandwich comprising electrically conductive surfaces and having a crystalline structure made of dielectric material between the electrically conductive surfaces, which structure of dielectric material can resonate when excited with energy having the desired frequency. Approximate dimensions of a piezoelectric element 36 suitable for use in this invention are approximately 1 inch in diameter and approximately 0.1 inch thick, on account of the features of the automated instrument relative to the positioning of the nozzles. Accordingly, typical diameters of piezoelectric element 36 can range from about 0.4 inch to about 2 inches. The electrical characteristics of the piezoelectric element 36 are similar to those of a capacitor but are highly affected by the load. In the case of the apparatus described herein, the load comprises the container 32, the container support 34, and the amount and type of liquid cleaner. An ideal liquid cleaner would be deionized water. The amount of liquid is typically in the range of from about 1 to about 3 mL. A capacitor has a certain volt-ampere terminal relationship such that the phase angle of the current always leads the phase angle of the voltage in a capacitor. Capacitive loads are difficult to drive at high frequencies, because capacitors appear to be a very low impedance to high frequencies. In other words, driving a capacitive load at high frequencies can resemble a short circuit to the amplifier. The capacitive load described herein can be modeled as an ideal capacitor with a series resistance and damping from the container 32, the mechanism for positioning the container, and the level of cleaning liquid “L” in the container 32. The piezoelectric element 36 will not come in contact with the liquid cleaner, so resistance to corrosion is not critical to the design of the piezoelectric element 36. The shape of the major surfaces of the piezoelectric element 36 is not critical. Suitable shapes for the major surfaces of the piezoelectric element include circular, as previously described, and polygonal, e.g., a regular polygon, e.g., a square.

The piezoelectric operational amplifier/driver 38 is a device used to amplify a small signal waveform to large signal waveform of similar shape but has the output characteristics that are capable of driving the piezoelectric device. Examples of a piezoelectric operational amplifier/driver 38 suitable for use in the invention described herein are well known to those of ordinary skill in the art of ultrasonic wave generation and are commercially available from, for example, Apex Microtechnology Corporation. A representative example of a piezoelectric operational amplifier/driver suitable for use in the method described herein is the PA78 Power Operational Amplifier, described in PA78RD brochure, December 2005, Apex Microtechnology Corporation, Tucson, Ariz., incorporated herein by reference. The electrical parameters of the piezoelectric operational amplifier/driver suitable for use in this invention, such as, for example, slew rate, supply voltage, output current, dissipation capability, and power bandwidth, are within the capabilities of the PA78RD power operational amplifier/driver, as described in the aforementioned brochure. In addition, for further information relating to piezoelectric operational amplifier/drivers suitable for use in this invention, see the brochure entitled “Driving Piezoelectric Actuators”, Application Note 44, Apex Microtechnology Corporation, Tucson, Ariz., also incorporated herein by reference.

The signal generator 40 will use an alternating excitation, such as, for example, a sinusoidal wave. It is contemplated that other waveforms can be used, such as, for example, square waves. The frequency and amplitude of the wave can be adjusted automatically by the apparatus described herein to maximize the energy transfer to the container 32 by dynamically measuring the impedance of the filled container 32. The particular type of signal generator 40 is not critical. The appropriate signal generator 40 suitable for carrying out the method of this invention can be readily determined by one of ordinary skill in the art.

It has been found that a sufficient amount of cavitation for carrying out the method of this invention can be generated at 37.9 kHz (50 volts p-p output), 90.9 kHz (100 volts p-p output), and 225 kHz (100 volts p-p output). “p-p” means peak-to-peak.

The method an apparatus described herein is capable of cleaning the tip of a nozzle having an opening having a typical diameter of about 0.03 inch.

It is envisioned that the apparatus and method described herein will be used by the operator of an automated instrument, such as, for example, the “PRISM” instrument, commercially available from Abbott Laboratories, in a periodic manner to reduce the amount of reagent build-up on tips of nozzles and therefore consequently reduce the number of dispensing verification errors and to increase the time between preventative maintenance intervals. In order to use the apparatus and method described herein, an operator will insert the container 32, the container support 34, and the piezoelectric element 36 in the positioning mechanism, which mechanism will then position the container 32 in the appropriate position for cleaning the tip 12a of the nozzle 12. The instrument will then prompt the operator to activate the apparatus. The container 32 can be filled with the cleaning medium via the nozzle itself. After the apparatus is activated, the apparatus is then able to carry out the cleaning method described herein. At the end of the cleaning operation, the instrument will prompt the operator to remove the container 32 and dispose of the liquid cleaning medium.

This invention results in reduction of liquid dispensing errors. In addition, the invention enables consistent, robust cleaning of the surfaces of dispensing nozzles by means of an automated process. The invention makes it possible to eliminate periodic cleaning of dispensing nozzles, and, consequently, to eliminate the labor-intensive task of disassembling the automated instrument, manual cleaning, and reassembling the automated instrument. The invention further eliminates possible errors resulting from faulty reassembly of the automated instrument. Most importantly, the user can perform cleaning without the need for a service call.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A method for cleaning residue from a nozzle, the method comprising the steps of:
(a) providing a nozzle for dispensing a liquid material capable of depositing a residue;
(b) providing a cleaning apparatus comprising a container for holding a cleaning liquid;
(c) generating ultrasonic excitation by means of the cleaning apparatus to create bubbles in a liquid container in the container; and
(d) removing any residue from the nozzle.

2. The method of claim 1, wherein ultrasonic excitation is generated by a signal generator that is capable of forming sine waves.

3. The method of claim 1, wherein said container for holding the cleaning liquid is made of a rigid, durable material.

4. The method of claim 3, wherein the rigid, durable material is ceramic.

5. The method of claim 3, wherein the rigid, durable material is stainless steel.

6. The method of claim 1, wherein the container for holding the liquid is coupled to a piezoelectric element.

7. The method of claim 1, wherein a support is inserted between the piezoelectric element and the container

8. The method of claim 7, wherein the support comprises a layer of composite material.

9. The method of claim 8, wherein the layer of composite material comprises epoxy resin bonded to a mesh.

10. An apparatus for cleaning residue from a nozzle, the apparatus comprising:
(a) a container for holding a cleaning liquid;
(b) a support for the container;
(c) a piezoelectric element;
(d) a signal generator; and
(e) a piezoelectric operational amplifier/driver.

11. The apparatus of claim 10, wherein the signal generator is capable of generating sine waves.

12. The apparatus of claim 10, wherein said container for holding the cleaning liquid is made of a rigid, durable material.

13. The apparatus of claim 12, wherein the rigid, durable material is ceramic.

14. The apparatus of claim 12, wherein the rigid, durable material is stainless steel.

15. The apparatus of claim 10, wherein the support for the container is inserted between the piezoelectric element and the container.

16. The apparatus of claim 10, wherein the support for the container comprises a layer of composite material

17. The apparatus of claim 16, wherein the layer of composite material comprises epoxy resin bonded to a mesh.
